(19) United States
(12) Patent Application Publication
(10) Pub. No.: US 2013/0323707 A1
(43) Pub. Date: Dec. 5, 2013

(54) INFORMATION BOARD WITH INTERCHANGEABLE GRAPHIC LAYER

(71) Applicants: Kurt William Lyons, Rochester, NY (US); Christopher Michael Phillips, Avon, NY (US); Gary Ray Fleckenstein, Waterport, NY (US)

(72) Inventors: Kurt William Lyons, Rochester, NY (US); Christopher Michael Phillips, Avon, NY (US); Gary Ray Fleckenstein, Waterport, NY (US)

(73) Assignee: QUORUM GROUP, LLC, Medina, NY (US)

(21) Appl. No.: 13/491,571

(22) Filed: Jun. 7, 2012

Related U.S. Application Data
(63) Continuation-in-part of application No. 29/423,599, filed on Jun. 1, 2012, now Pat. No. D688745.

(51) Int. Cl. B43L 1/12

(52) U.S. Cl. 434/416

(57) ABSTRACT

Information boards include a graphic layer and a transparent or translucent dry erase writing surface. The information boards include one or more non-permanent attachment mechanisms that allow for selective removal and replacement of the graphic layer. Additionally, the information boards can optionally include a magnetically attractable layer positioned behind the graphic layer. The magnetically attractable layer can allow for the attachment of notes or other objects to the dry erase writing surface via a magnet. One will appreciate that implementations of the present invention are particularly suited for use in homes, schools, hospitals, businesses, and other locations where removing and replacing a graphic layer in a dry erase board may be desired.

### CROSS-REFERENCE TO RELATED APPLICATIONS

The present invention in a continuation-in-part of US Design Patent Application No. US09/64107, filed Nov. 12, 2009, entitled “COMMUNICATION BOARD” The entire contents of the above-referenced application are incorporated by reference herein.

### BACKGROUND

### Background and Relevant Art

An individual may display information in a variety of ways using an information board. For example, some information boards may include a metallic or cork board backing to which an individual may post messages and other information using magnets and/or push pins. Other information boards, such as dry erase boards, may include an erasable surface on which an individual may write messages and other information. An individual or individuals may use these dry erase boards in a variety of different applications. For example, an individual or individuals may use dry erase boards in homes, hospitals, classrooms, and businesses.

Conventional dry erase boards typically include an opaque white writing surface. Furthermore, some conventional dry erase systems include a graphic printed on the opaque white writing surface. For example, a dry erase board in a classroom may include a series of parallel horizontal lines that may be used for spelling or cursive writing instruction. In a home, a dry erase board may include a calendar grid, where note deadlines, appointments, or other commitments may be written. Similarly, hospital dry erase boards may include a graphic having lines for a patent name, nurse name, and room number.

Unfortunately, conventional dry erase boards do not provide the ability to change or customize the graphic or other functional aspects of the board. Thus, when an individual wants to change the graphic that appears on the writing surface of a dry erase board, they typically must replace the board altogether. Indeed, with some conventional dry erase boards, changing the graphic layer may be impossible because the graphic layer forms part of the actual dry erase writing surface. Thus, if a person wants to change or replace a graphic layer in a conventional dry erase board, an entirely new dry erase board having the desired graphic layer may need to be purchased.

Accordingly, there are a number of problems that exist with conventional dry erase boards and information boards.

### BRIEF SUMMARY

One or more implementations of the present invention solves one or more of the foregoing, or other, problems in the art with systems, apparatus, and methods for selectively removing and replacing a graphic layer from a dry erase board. In particular, implementations of the present invention comprise dry erase boards having a transparent or translucent dry erase surface and a graphic layer positioned behind the dry erase surface. The configuration of the dry erase board can allow for easy replacement of the graphic layer with another graphic layer. One will appreciate that implementations of the present invention are particularly suited for use in homes, schools, hospitals, businesses, and other locations where removing and replacing a graphic layer in a dry erase board may be desired.

For example, in one implementation an information board includes a backing member, a transparent or semi-transparent dry erase writing surface, and a graphic layer. The graphic layer is positioned between the dry erase writing surface and the backing member. Furthermore, a non-permanent attachment mechanism secures the graphic layer between the dry erase writing surface and the backing member such that the graphic layer may be selectively removed and replaced.

In another implementation, an information board includes a backing member having a front side and a back side. The information board further includes a magnetically attractable layer positioned in front of the front side of the backing member. Additionally, a graphic layer is positioned in front of the magnetically attractable layer so as to at least partially conceal the magnetically attractable layer. The information board also includes a dry erase writing surface positioned in front of the graphic layer. The dry erase writing surface is transparent or translucent such that the graphic layer is visible through the dry erase writing surface. Furthermore, a non-permanent attachment mechanism secures the graphic layer and the dry erase writing surface to the backing member such that the graphic layer and the dry erase writing surface may be selectively detached from the backing member.

In addition to the foregoing, yet another implementation of an information board includes a backing member having a front side and a back side. The information board also includes a graphic layer positioned in front of the backing member so as to at least partially conceal the backing member. Also, the information board includes a dry erase writing surface positioned in front of the graphic layer. The dry erase writing surface is transparent or translucent such that the graphic layer is visible through the dry erase writing surface. Additionally, a self-aligning mounting mechanism removably secures the backing member to a support surface. The self-aligning mounting mechanism includes a triangular aperture extending into the back side of the backing member. The self-aligning mounting mechanism also includes a triangular or trapezoidal mounting bracket configured to mate and self-align with the triangular aperture. Furthermore, the information board includes a non-permanent attachment mechanism that secures the graphic layer and the dry erase writing surface to the backing member. The non-permanent attachment mechanism allows the graphic layer and the dry erase writing surface to be selectively detached from the backing member.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates a perspective view of an information board according to one or more implementations of the present invention;

FIG. 2 illustrates an exploded view of the information board of FIG. 1;

FIG. 3 illustrates a back view of the information board of FIG. 1;

FIG. 4 illustrates a front view of the information board of FIG. 1, wherein the information board of FIG. 4 includes a different graphic layer;

FIG. 5 illustrates a perspective view of another information board according to one or more implementations of the present invention;

FIG. 6 illustrates an exploded view of the information board of FIG. 5;

FIG. 7 illustrates a perspective view of yet another information board according to one or more implementations of the present invention;

FIG. 8 illustrates an exploded view of the information board of FIGS. 7; and

FIG. 9 illustrates a perspective view of yet another information board according to one or more implementations of the present invention.

### DETAILED DESCRIPTION

Implementations of the present invention provide systems, apparatus, and methods for selectively removing and replacing a graphic layer from a dry erase board. In particular, implementations of the present invention comprise dry erase boards having a transparent or translucent dry erase surface and a graphic layer positioned behind the dry erase surface. The configuration of the dry erase board can allow for easy replacement of the graphic layer with another graphic layer. One will appreciate that implementations of the present invention are particularly suited for use in homes, schools, hospitals, businesses, and other locations where removing and replacing a graphic layer in a dry erase board may be desired.

In addition, and as will be appreciated more fully herein, one or more implementations of the present invention may also allow an individual to selectively remove and replace parts of a dry erase board other than a graphic layer. For example, an individual may want to replace a transparent or semi-transparent dry erase writing surface if it gets scratched, broken, or otherwise damaged. In such a situation, an individual may replace the dry erase writing surface with a new dry erase surface without having to replace the entire dry erase board.

Further, implementations of the present invention may allow a person to selectively combine different types of information boards together. For example, as described in more detail hereafter, one information board may include both a dry erase board portion and a cork board portion. An individual may selectively remove the cork board portion and replace it with a magnetic board, another dry erase board, or another type of information board. Further still, an information board may include a metallic layer that is selectively positioned behind a dry erase writing surface so that the dry erase board also serves as a magnetic board.

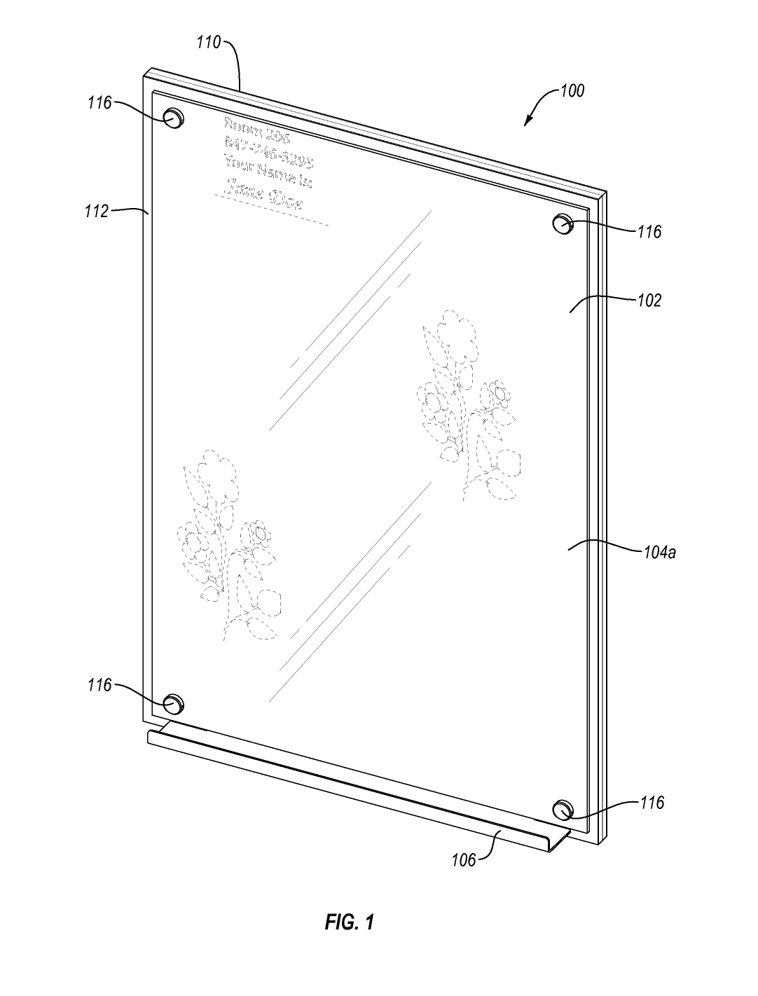

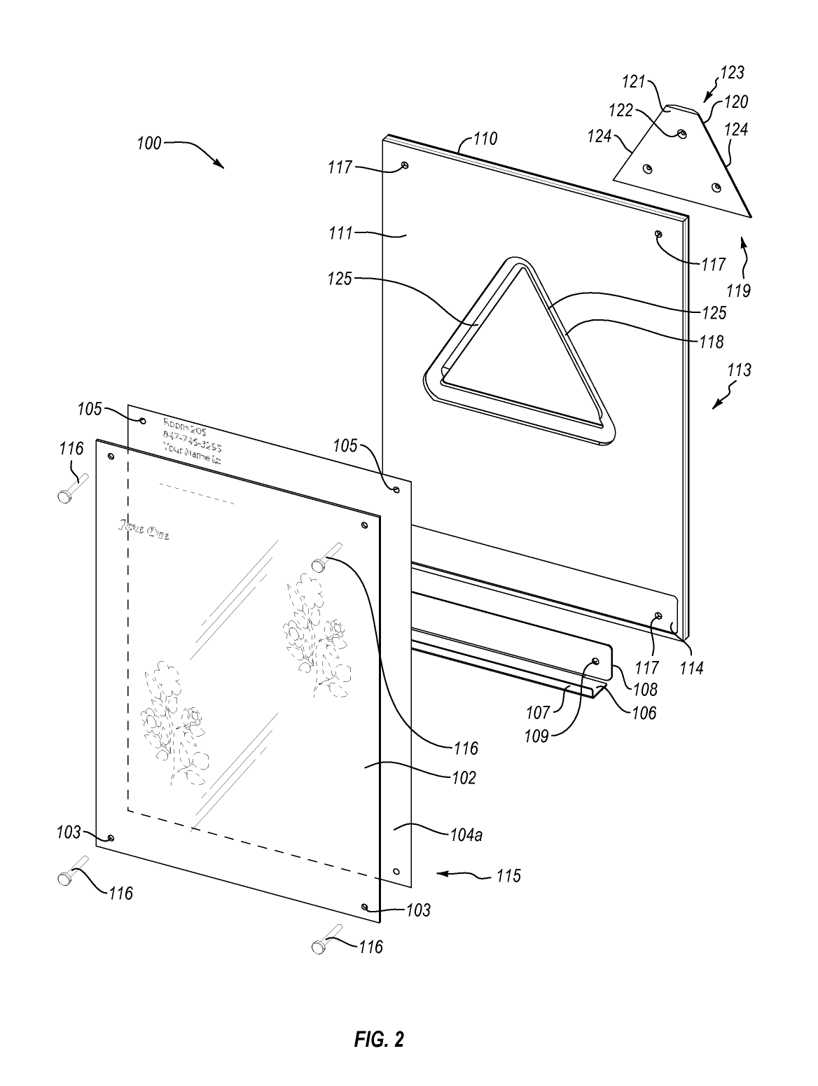

FIGS. 1 and 2 illustrate an information board 100 according to one or more implementations of the present invention. Specifically, information board 100 is a dry erase board. FIG. 1 illustrates a perspective view of information board 100, while FIG. 2 illustrates an exploded perspective view of information board 100. As can be seen from these figures, information board 100 can include a number of separate components. Specifically, information board 100 includes a dry erase writing surface 102, a graphic layer 104a, and a backing member 110.

In one or more implementations, the dry erase writing surface or lens 102 is translucent, transparent, or semi-transparent. Thus, in at least one implementation, the dry erase writing surface 102 is clear and transparent. In alternative implementations, the dry erase writing surface 102 is colored and translucent. As explained in greater detail below, the transparency of the dry erase writing surface 102 can allow one to at least partially see a graphic layer 104a positioned behind the dry erase writing surface 102.

The dry erase writing surface 102 can comprise a sheet or panel including one or more layers of material. Specifically, such materials can include, but are not limited to, ceramic, glass, plastic, polyethylene terephthalate (PET), polyethylene terephthalate with glycol-modification (PETG), acrylonitrile butadiene-styrene (ABS), polyvinyl chloride (PVC), polyvinyl butyral (PVB), ethylene vinyl acetate (EVA), polycarbonate (PC), styrene, polymethyl methacrylate (PMMA), polyolefins (low and high density polyethylene, polypropylene), thermoplastic polyurethane (TPU), cellulose-based polymers (cellulose acetate, cellulose butyrate or cellulose propionate), poly lactic acid (PLA), or the like. Furthermore, the dry erase writing surface 102 can include other glass or thermoplastic polymers or thermoplastic polymer blends, or combinations and mixtures thereof.

In addition, dry erase writing surface 102 can include any number other layers or coatings. For example, in one or more implementations, the dry erase writing surface 102 comprises a polymeric material with a low volatile compound coating. Such coating can yield a clean, ghost free erasure of a dry erase marker. In any event, a person may use a dry erase marker to write on dry erase writing surface 102. Ink from a dry erase marker may be easily wiped off and removed from dry erase writing surface 102 using a towel, a piece of felt, or another material.

Information board 100 also includes a graphic layer 104a. Graphic layer 104a is positioned behind dry erase writing surface 102. Because dry erase writing surface 102 is transparent or semi-transparent, graphic layer 104a can be seen, at least partially, through dry erase writing surface 102. Graphic layer 104a may comprise paper, plastic, a metal sheet, or another thin material member. Graphic layer 104a may include any number of different designs and/or images. For example, graphic layer 104a may include a calendar grid, a photograph of a person or a scenic place, etc. Alternatively, a graphic layer may simply be a solid or multi-colored sheet having no additional design or image printed thereon. As can be seen in FIGS. 1 and 2, graphic layer 104a contains a flower patterned print. A dry erase marker may be used to write on dry erase writing surface 102 over graphic layer 104a.

Graphic layer 104a may span the entire back surface of a dry erase writing surface 102, or only a portion thereof. For example, one may position a graphic layer 104a behind a top or bottom portion of a dry erase writing surface. Graphic layer 104a can also be larger than the dry erase writing surface 102. With regard to information board 100, the surface size of graphic layer 104a is substantially the same as the surface size of dry erase writing surface 102. As explained in greater detail below, the information board 100 can comprise one or more components configured to allow for easy and efficient replacement or changing of the graphic layer 104a.

Information board 100 can also optionally include a tray member 106. Tray member 106 can provide a structure for dry erase markers and/or other materials to be held while not in use. While tray member 106 is positioned at the base of dry erase writing surface 102 in the implementation shown in the drawings, one will appreciate that in alternative implementation, the tray member 106 may have a position anywhere on the information board 100. For example, in another implementation, the tray member 106 is located at the top or to a lateral side of a dry erase writing surface 102.

As shown particularly by FIG. 2, tray member 106 can comprise a surface extending generally perpendicularly to the dry erase writing surface 102. Tray member 106 can optionally include a front lip 107 extending upward from the main surface of tray member 106. The lip 107 can help prevent markers or other objects from inadvertently falling from the tray member 106.

Tray member 106 can further include a mounting flange 108 (see FIG. 2), which extends at least partially behind dry erase writing surface 102. As explained in greater detail below, the mounting flange 108 can secure the tray member 106 to the backing member 110. In particular, the mounting flange 108 can include one or more mounting holes 109 through which fasteners may extend to secure the tray member 106 to the backing member 110. In alternative implementations, an adhesive or other fastening mechanism can secure the tray member 106 to the backing member 110.

Tray member 106 and/or mounting flange 108 may have a length that is substantially equal to one or more sides of a dry erase writing surface 102. Alternatively, tray member 106 and/or mounting flange 108 may have a length that is more or less than the length of one or more of the sides of a dry erase writing surface. With regard to information board 100 shown in FIGS. 1 and 2, try member 106 is slightly shorter than the length of the bottom side of dry erase writing surface 102.

Information board 100 further includes a backing member 110. Backing number 110 may comprise any number of different natural and synthetic materials including but not limited to plastic, wood, metal, etc. Backing member 110 may completely enclose the back side of information board 100, or it may enclose only a portion thereof. Backing member 110 may include a border 112 that surrounds dry erase writing surface 102 in whole or in part. Border 112 may be elevated so that it is flush with the surface of dry erase writing surface 102. Alternatively, backing member 110 can have a size and configuration such that no border exists around the perimeter of dry erase writing surface 102.

Backing member 110 can includes a front side or surface 111 that faces toward the dry erase writing surface 102 (i.e., the front of the information board 100), and an opposing back side or surface 113. The front side 111 of backing member 110 may be smooth or uneven. For example, the front side 111 of backing member 110 may include one or more recesses sized and configured to accommodate one or more components of information board 100. In particular, the front side 111 of backing member 110 includes a recessed portion 114, into which all or part of mounting flange 108 of tray member 106 may fit so as to create a smooth and even surface for dry erase writing surface 102 and graphic layer 104a to be secured.

An attachment mechanism may secure dry erase writing surface 102, graphic layer 104a, and/or tray member 106 to backing member 110. An attachment mechanism, according to one or more implementations of the present invention, may permanently secure components to dry erase writing surface 102, graphic layer 104a, and/or tray member 106 to backing member 110. For example, a permanent attachment mechanism may comprise an adhesive, one or more nails, rivets, or another permanent attachment mechanism.

Alternatively, an attachment mechanism may be non-permanent such that a person may selectively disengage the attachment mechanism and remove and/or replace one or more components from backing member 110. For example, a non-permanent attachment mechanism may comprise one or more screws, Velcro pieces, clamps, clips, snaps, magnets, or another non-permanent attachment mechanism.

With regard to information board 100 shown in FIGS. 1-2, attachment mechanism 115 is non-permanent such that one may selectively disengage attachment mechanism 115. Specifically, attachment mechanism 115 comprises one or more fasteners 116 that extend through mounting holes 103 in dry erase writing surface 102, mounting holes 105 in graphic layer 104a, and mounting holes 109 in tray member 106 and into threaded openings 117 in backing member 110. In particular, the attachment mechanism 115 comprises four set screws 116. In alternative implementations, the attachment mechanism 115 can comprise Velcro pieces, clamps, clips, snaps, magnets, or other selectively removable fasteners.

As shown by FIGS. 1 and 2, in one or more implementations the mounting holes 103, 105 and threaded openings 117 are in a location to maximize the viewable/useable area of the dry erase writing surface 102. In particular, the mounting holes 103, 105 and threaded openings 117 proximate the corners of the dry erase writing surface 102, graphic layer 104a, and backing member 110. In alternative implementations, the mounting holes 103, 105 and threaded openings 117 can be located peripherally around the edges of the information board 100, but not necessarily in the corners.

To engage attachment mechanism 115 and secure dry erase writing surface 102, graphic layer 104a, and tray member 106 to backing member 110, one need only to rotate, by hand or with a tool, the set screws 116 through the holes 103, 105, 109 in dry erase writing surface 102, graphic layer 104a, and tray member 106 and into threaded openings 117. The set screws 116 can have a size and shape to facilitate rotation by hand. Similarly, one may selectively remove dry erase writing surface 102, graphic layer 104a, and tray member 106 from backing member 110 by rotating the set screws 116 in an opposite direction and disengaging attachment mechanism 115.

Thus, dry erase writing surface 102, graphic layer 104a, and tray member 106 are selectively removable from backing member 110. Indeed, one may disengage attachment mechanism 115 in order to remove and/or replace dry erase writing surface 102, graphic layer 104a, and/or a tray member 106. In one or more implementations of the present invention, a person may remove dry erase writing surface 102, graphic layer 104a, and/or a tray member 106 and replace these components with a different information board component. For example, a person may replace these components with a metallic board, a cork board, etc.

Furthermore, while FIGS. 1 and 2 illustrate tray member 106 being secured to the backing member 110 via the attachment mechanism 115, the present invention is no so limited. For example, in alternative implementations tray member 106 can extend behind or between layers of the backing member 110 or in front of dry erase writing surface 102. Thus, mounting flange 108 need not extent between dry erase writing surface 102 and backing member 110. In such implementations, a permanent attachment mechanism can secure the tray member 106 to the backing member 110 such that the tray member 106 is not selectively removable.

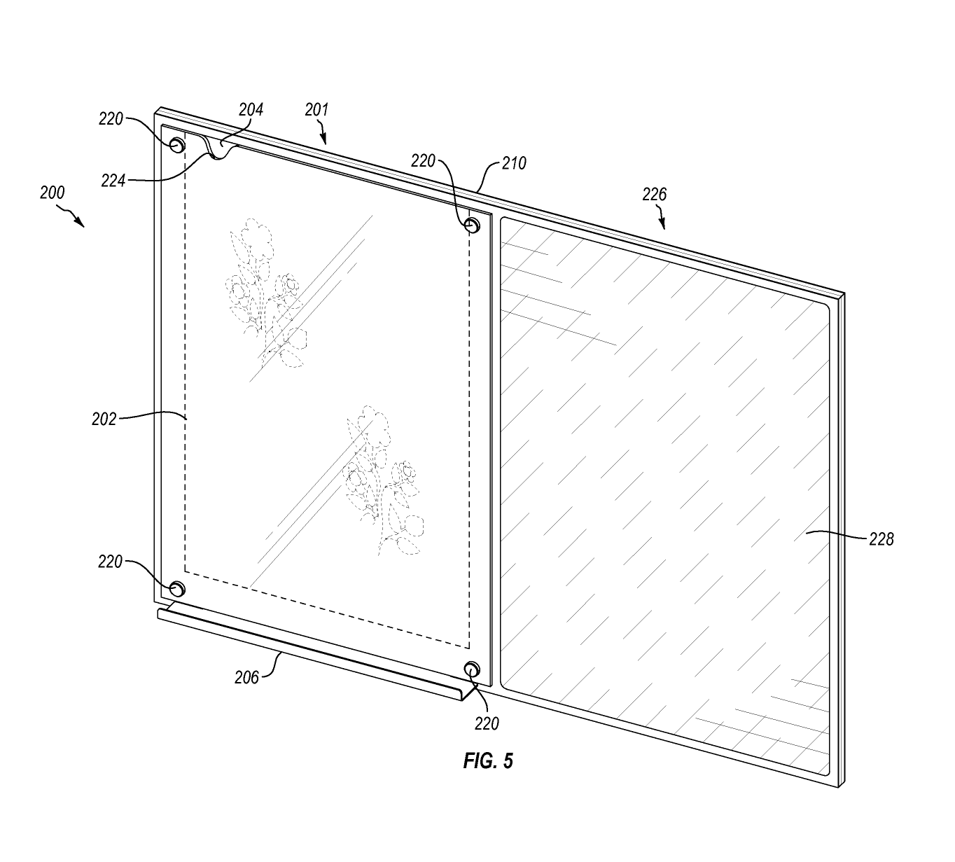

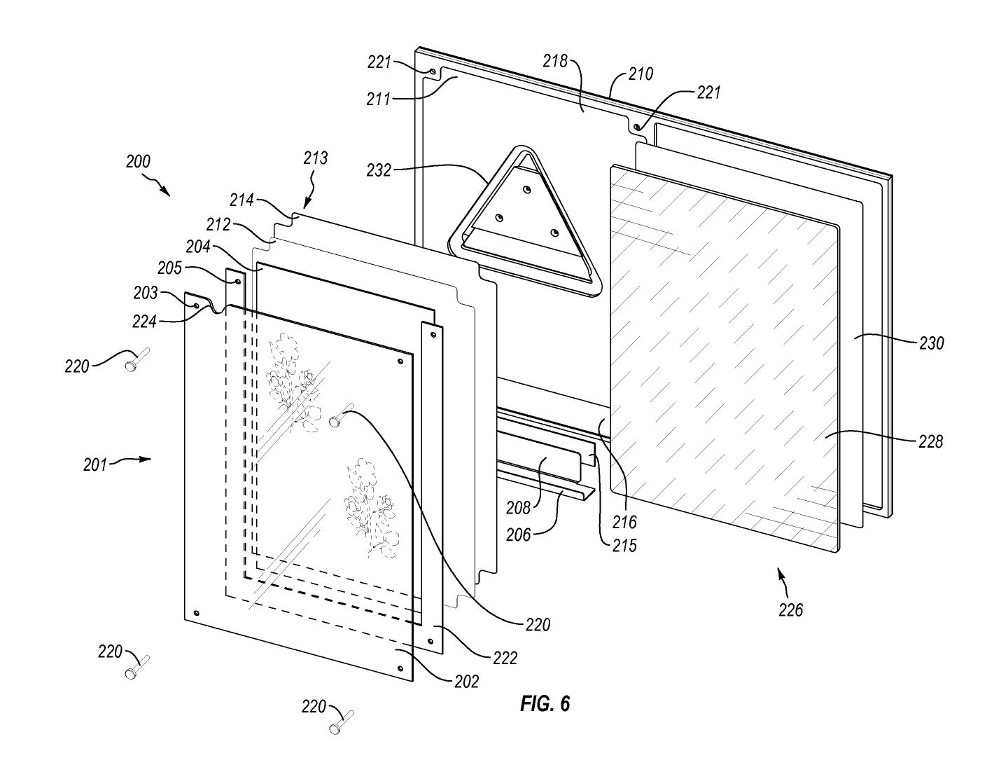

As discussed in more detail hereafter in reference to FIGS. 5 and 6, in one or more implementations of the present invention, an attachment mechanism need not be selectively disengaged in order to remove and replace certain components from a dry erase board. For example, in one or more implementations of the present invention, one may remove and replace a graphic layer without disengaging an attachment mechanism. Thus, a graphic layer may be removed and replaced even if a dry erase writing surface is attached to a backing member via a permanent attachment mechanism.

In one or more implementations, the information board 100 can include a mounting mechanism for securing the information board to a support surface (e.g., wall, or other structure). In one or more implementations, the mounting mechanism is separate from the attachment mechanism 115. This can allow a user to mount the information board 100 to a structure without having to disengage the attachment mechanism 115 or vice versa. Thus, in one or more implementations the information board 100 allows a user to replace the graphic layer 104a or dry erase writing surface 102 without having to dismount the information board 100 from its mounted position on a wall or otherwise.

In particular, backing member 110 may include one or more mounting mechanisms that selectively or permanently secure information board 100 to an external surface. A mounting mechanism can be any mechanism that secures an information board to a desired surface. For example, a mounting mechanism may comprise one or more hooks secured to a back side of backing member 110 that can be secured to nails, screws, etc. in a wall.

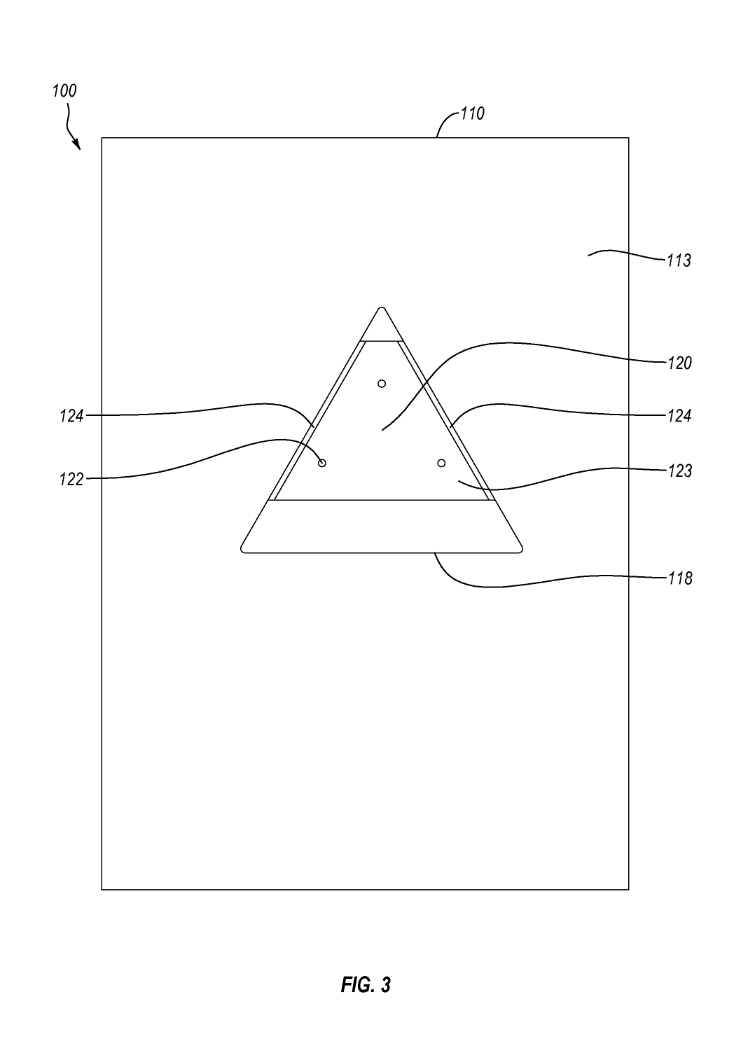

As illustrated by FIGS. 2 and 3, the mounting mechanism 119 of information board 100 comprises a triangular aperture 118 in backing member 110 and a triangular or trapezoidal shaped mounting bracket 120. The triangular aperture 118 can include recessed grooves 125. The recessed grooves 125 can comprise tapered surfaces that extend from the back surface 113 of backing member 110 radially outward and toward the front surface 111 of backing member 110. As explained in greater detail below, recessed grooves 125 can cooperate with mounting bracket 120 to secure the backing member 110 to mounting bracket 120.

Mounting bracket 120 can include one or more holes 122 through which screws, nails, or other fasteners may extend in order to secure mounting bracket 122 to a surface, such as a wall. Mounting bracket 120 can also include flanges 124 that are positioned along one or more edges of mounting bracket 120. Flanges 124 can extend from a back surface 123 of the mounting bracket 120 generally outward from the center of mounting bracket 120 to the front surface 121 of the mounting bracket 120. Thus, flanges 124 may form an undercut or groove between the front surface 121 of the mounting flange 120 and a surface to which the mounting flange 120 is secured.

The mounting bracket 120 can include a shape corresponding to the aperture 118. For example, FIGS. 2 and 3 illustrate that the aperture 118 is triangular and the mounting bracket 120 is trapezoidal. In alternative implementations, the mounting bracket 120 can also have a triangular shape. In any event, the aperture 118 can be larger than the mounting bracket 120 to allow the mounting bracket 120 to be positioned and removed from the aperture 118 as explained below.

One may secure information board 100 to mounting bracket 120 by inserting all or part of mounting bracket 120 through aperture 118. In one or more implementations, only the flanges 124 may extend through the aperture 118. The recessed grooves 125 of aperture 118 may be sized and shaped into the undercut portion between flanges 124 and the surface to which mounting bracket 120 is secured. In other words, the mounting bracket 120 and the aperture 118 can mate by the flanges 124 extending into the aperture 118. Once mounting bracket 120 is inserted at least partially through aperture 118, one may lower information board 100 so that recessed grooves 125 of aperture 118 are positioned between flanges 124 and the surface to which mounting bracket 120 is secured, thereby securing information board 100 to the flat surface.

This mounting mechanism 119 may allow the back side 113 of information board 100 to mount flush with the surface to which mounting bracket 120 is secured. One may selectively dismount information board 100 from mounting bracket 120 and the surface to which it is secured by simply lifting information board 100 in an upward direction and disengaging the recessed grooves 125 of aperture 118 from between flanges 124 and the surface to which mounting bracket 120 is secured and removing mounting bracket 120 from aperture 118.

One will appreciate in light of the disclosure herein that the triangular shape of the aperture 118 can cause the aperture 118 to self-align with the mounting bracket 120. Furthermore, the corresponding triangular portions of the aperture 118 and mounting bracket 120 can restrict or prevent side to side movement of the information board 100 relative to the mounting bracket 120, and thus, the wall or other surface to which the information board 100 is secured. Thus, the information board 100 can self-align and resist unintentional repositioning by a passerby or otherwise.

FIG. 3 illustrates a back view of information board 100 with mounting bracket 124 secured within aperture 118. As can be seen in FIG. 3, flanges 124 are positioned within aperture 118 such that information board 100 cannot be separated from mounting bracket 124 without disengaging the edges or recessed grooves 125 of aperture 118 from behind flanges 124. As stated previously, one may disengage the edges of aperture 118 from mounting bracket 124 by moving information board 100 in an upward direction with respect to mounting bracket 120. In alternative implementations, aperture 118 may not extend entirely through backing member 110. For example, the back side 113 of a backing member 110 may have a recessed portion that accommodates the flanges 124 of a mounting bracket 120 or other components of a mounting mechanism that does not extend completely through the backing member 110.

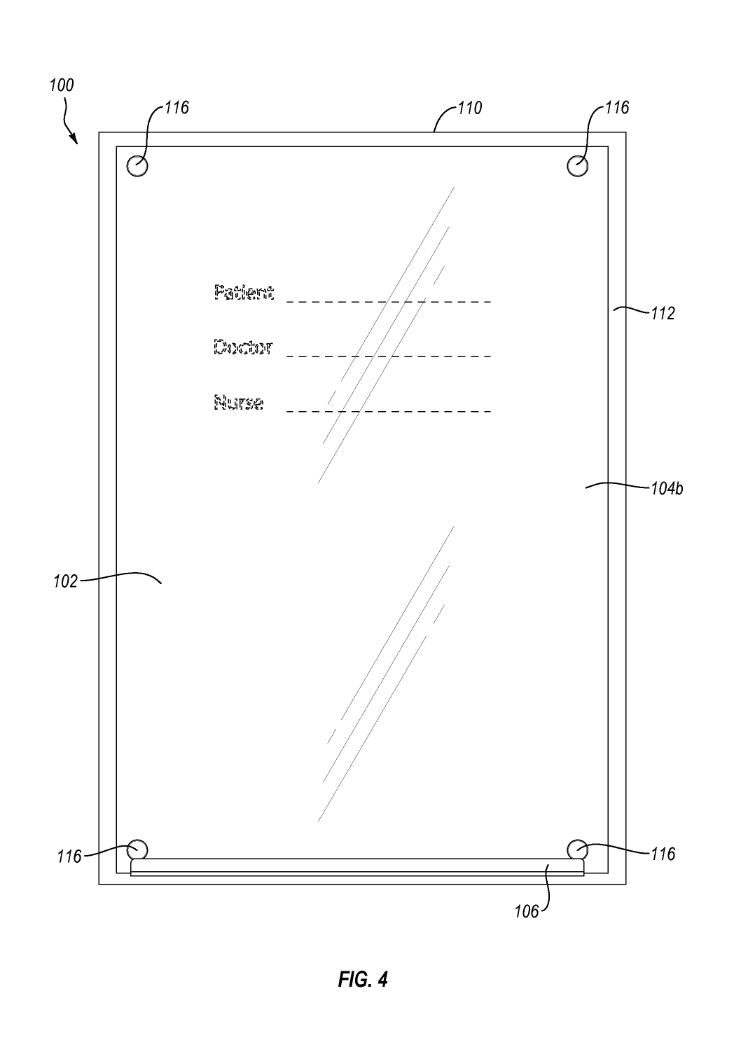

FIG. 4 illustrates a front view of information board 100, where graphic layer 104a having the flower patterned print has been removed and replaced with graphic layer 104b. Graphic layer 104b is designed for use in a medical clinic or hospital and includes fields where a doctor's name, a nurse's name, and a patient's name may be written on dry erase writing surface 102 using a dry erase marker. One will appreciate that a user can erase the names/messages written on dry erase writing surface 102 without erasing the printed material on graphic layer 104b. Hospital staff or other user can change or place new names/messages on dry erase writing surface 102 as necessary.

Thus, the information board 100 allows a user to quickly and easily change the graphic layer as desired. For example, an individual may want to change a dry erase board graphic layer so that the graphic layer is seasonally appropriate. Specifically, an individual may want to replace a snowy field graphic layer with a more colorful flowers graphic layer during spring. Alternatively, an individual may want to change a dry erase board graphic layer based on an educational curriculum. Specifically, a teacher may want to replace a graphic layer having horizontal lines with a graphic layer having geographic significance, such as a map of the United States. The information board 100 can allow for such changes, without having to replace the information board 100 or even dismount it from the wall.

FIGS. 5 and 6 illustrate an information board 200 where one need not disengage the attachment mechanism in order to replace a graphic layer. Information board 200 includes a dry erase board/magnet board section 201, and a cork board section 226. FIG. 5 illustrates a perspective view of information board 200, while FIG. 6 illustrates an exploded perspective view of information board 200. Like information board 100, dry erase board/magnet board section 201 of information board 200 includes dry erase writing surface 202, a graphic layer 204, and a tray member 206. Tray member 206 includes a mounting flange 208, which extends at least partially behind dry erase writing surface 202.

Unlike information board 100, tray member 206 is secured to backing member 210 via a permanent attachment mechanism. Specifically, an adhesive layer 215 permanently secures tray member 206 to backing member 210. Also unlike information board 100, dry erase board/magnet board section 201 also includes a magnetically attractable layer 212 as shown by FIG. 6. Magnetically attractable layer 212 can comprise a material to which a permanent or other magnet can attract. For example, magnetically attractable layer 212 can comprise a metal layer, such as iron, nickel, cobalt, gadolinium, dysprosium and alloys such as steel that contain ferromagnetic metals.

Magnetically attractable layer 212 may span the entirety of a dry erase writing surface 202, or only a portion thereof. For example, magnetically attractable layer 212 may be positioned behind a top or bottom portion of a dry erase writing surface 102. With regard to information board 200, the size of magnetically attractable layer 212 is substantially similar to the size of dry erase writing surface 202. Like tray member 206, magnetically attractable layer 212 is secured to backing member 210 via a permanent attachment mechanism. Specifically, magnetically attractable layer 212 is secured to backing member 210 via an adhesive layer 214.

As shown by FIG. 6, the magnetically attractable layer 212 can include cutouts 213 at the corners thereof. The cutouts 213 can ensure that the removable fasteners 310 do not extend through the magnetically attractable layer 212. Thus, the magnetically attractable layer 212 may not be disturbed when replacing the graphic layer 204.

As can be seen in FIG. 6, the front side 211 of backing member 210 includes a recessed portion 216 into which all or part of mounting flange 208 of tray member 206 can fit. The front side 211 of backing member 210 includes a second recessed portion 218 into which all or part of ferrous metal layer 212 can fit. Once inserted into recessed portions 216 and 218, the surfaces of mounting flange 208 and magnetically attractable layer 212 may be substantially flush with the outer un-recessed edges of the front surface 211 of backing member 210. This provides a substantially flat surface onto which dry erase writing surface 202 and graphic layer 204 may be secured.

Information board 200 also includes a spacing member 222. Specifically, spacing member 222 is positioned between portions of dry erase writing surface 202 and magnetically attractable layer 212. Spacing member 222 is generally u-shaped and is positioned between dry erase writing surface 202 and magnetically attractable layer 212 generally along their left, right, and bottom sides. As explained in greater detail below, the spacing member 222 can comprise a non-permanent attachment mechanism that secures the graphic layer 204 to the information board 200.

A non-permanent attachment mechanism secures dry erase writing surface 202, graphic layer 204, and spacing member 222 to backing member 210. Specifically, four set screws 220 selectively secure dry erase writing surface 202, graphic layer 204, and spacing member 222 to backing member 210. While ferrous metal layer 212 and tray member 206 are permanently secured to backing member 210 via adhesive layers 214 and 215, set screws 220 also secure ferrous metal layer 212 and tray member 206 to backing member 210 by squeezing these components between writing surface 202 and backing member 210. In addition, while set screws 220 directly secure dry erase writing surface 202 and spacing member 222 to backing member 210, they do not directly secure graphic layer 204 to backing member 210. Rather, set screws 220 indirectly secure graphic layer 204 to backing member 210. Specifically, graphic layer 204 rests within a gap created between dry erase writing surface 202 and ferrous metal layer 212, which is created by spacing member 222.

In particular, set screws 220 extend through holes 203, 205 in dry erase writing surface 202 and spacing member 222 and into threaded openings 221 in backing member 210. Thus, when one engages set screws 220, spacing member 222 contacts dry erase writing surface 202 and ferrous metal layer 212 along their left, right, and bottom sides, which creates some separation, or a gap, between dry erase writing surface 202 and ferrous metal layer 212. Spacing member 222 extends only along a portion the top sides of dry erase writing surface 202 and ferrous metal layer 212. Thus, one may selectively remove graphic layer 204 and place a new graphic layer through the space between top sides of dry erase writing surface 202 and magnetically attractable layer 212.

Spacing member 222 can create enough space between dry erase writing surface 202 and magnetically attractable layer 212 corresponding to the size (i.e., thickness) of graphic layer 204. Thus, spacing member 222 may be thin, for example no more than one or two millimeters. In addition, a spacing member 222 can extend behind an entire length of the left, right, and bottom sides of a dry erase writing surface. In alternative implementations, spacing member 222 may extend behind only parts of the left, right, and bottom sides of dry erase writing surface. Alternatively, a spacing member 222 may be positioned behind only part of one or two sides of a dry erase writing surface 202. Further, spacing member 222 can comprise a single component. Alternatively, spacing member 222 may comprise, for example, several different pieces that are positioned between a dry erase writing surface 202 and a backing member 210. Further, in alternative implementations, a spacing member 222 may be an integrally formed piece with dry erase writing surface 202, magnetically attractable layer 212, or backing member 210.

Graphic layer 204 has a size such that when set screws 220 are engaged and dry erase writing surface 202 and spacing member 222 are secured to backing member 210, one may selectively insert and remove graphic layer 204 from the space between dry erase writing surface 202 and magnetically attractable layer 212. Thus, one may remove graphic layer 204 without the need to disengage set screws 220. Therefore, even if dry erase writing surface 202 and spacing member 222 were secured to backing member 210 via a permanent attachment mechanism, graphic layer 204 would still be selectively removable.

In order to facilitate the removal of graphic layer 204 from dry erase board/magnet board section 201 of information board 200, one or more edges of dry erase writing surface 202 may include an indentation 224. In dry erase board/magnet board section 201, indentation 224 is along the top edge of dry erase writing surface 202, which is the only side that is not positioned directly above a portion of spacing member 222 in the illustrated implementation. A person may remove graphic layer 204 from behind dry erase writing surface 202 by using his or her finger to contact graphic layer 204 at indentation 224 and sliding graphic layer 204 upward and out from behind dry erase writing surface 202.

In alternative implementations, a user can selectively remove and/or insert graphic layer 204 a side of a dry erase writing surface 202 other than the top surface. For example, in one implementation, spacing member 222 may not extend along an entire left side of a dry erase writing surface 202. Thus, one may selectively insert and/or remove a graphic layer in this implementation through the left side of the dry erase writing surface 202.

A person may use dry erase markers to write messages on dry erase writing surface 202. In addition, due to the properties of magnetically attractable layer 212, a person may attach messages or other things to dry erase writing surface 202 using one or more magnets.

Further, information board 200 includes a cork board section 226. A cork board section, according to one or more implementations of the present invention, attach to a backing member adjacent to a dry erase board and/or a magnet board section. As used herein, the term “adjacent” includes any side of a dry erase board and/or a magnet board section. Specifically, a cork board section may be positioned above or below or to either a left or right side of a dry erase board and/or a magnet board section. In one or more implementation, cork board section 226 may be positioned on two sides of a dry erase board and/or a magnet board section. For example, a first cork board section may be positioned on a left side of a dry erase board and/or a magnet board section and a second cork board section may be positioned below a dry erase board and/or a magnet board section. Further still, a cork board section may be positioned on all sides of a dry erase board and/or a magnet board section and thus surround a dry erase board and/or a magnet board section like a border.

With regard to information board 200 illustrated in FIGS. 5 and 6, cork board section 226 includes a cork board material 228 and an attachment mechanism, specifically an adhesive layer 230, that secures the cork board material 228 to backing member 210. A person may attach messages to cork board section 226 using, for example push pins, staples, or another device that may be at least partially inserted into cork board material 228.

In alternative implementations, a cork board section of an information board may include a magnetically attractable layer positioned behind a cork board material. This would enable a person to secure notes and other things to the cork board material using push pins, staples, etc., as well as magnets. Such a magnetically attractable layer may attach to the information board backing member via its own attachment mechanism or a single attachment mechanism may secure both a cork board material and a magnetically attractable layer to a backing member.

Further still, one may selectively secure a cork board material to a backing member via an attachment mechanism that is allows a user selectively disengage it.

In such an implementation, one may replace a cork board section with another type of information board. For example, one may remove and replace cork board section 226 with another dry erase board section.

Information board 200 also includes a mounting mechanism 232. Similar to the mounting mechanism 119 of information board 100, mounting mechanism 232 comprises an aperture in backing member 210 and a mounting bracket. Information board 200 may include a second mounting mechanism (not shown) that is positioned behind cork board section 226.

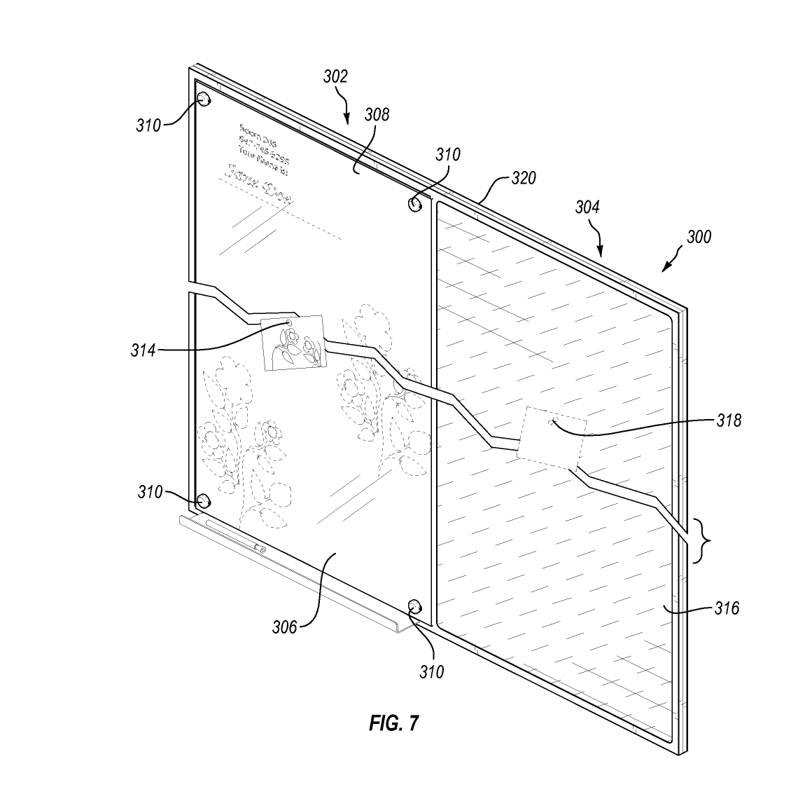

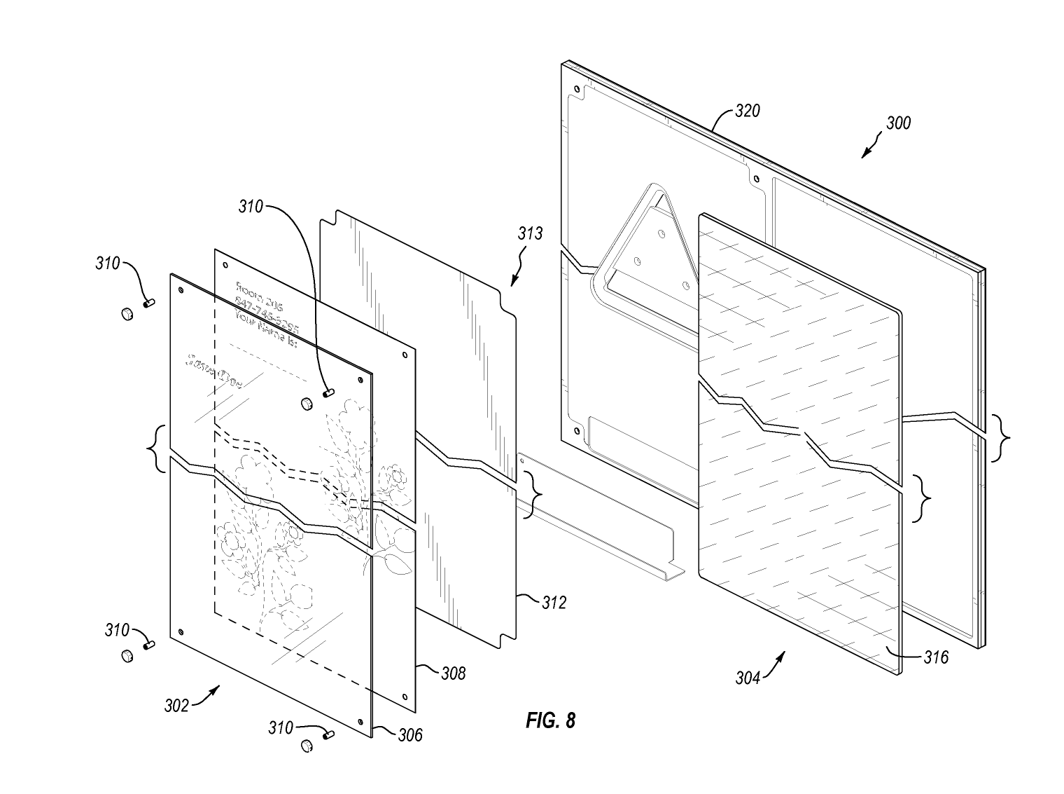

Information boards of one or more implementations of the present invention may have a wide variety of shapes, sizes, and configurations. For example, FIGS. 7 and 8 illustrate an information board 300 comprising a dry erase board section 302 and a cork board section 304. As can be seen in FIG. 8, a dry erase board section 302 includes a dry erase writing surface 306, and graphic layer 308. Fasteners (e.g., set screws) 310 selectively secure dry erase writing surface 306 and graphic layer 308 to a backing member 320. Set screws 310 are configured to allow one to selectively disengage them in order to remove and/or replace dry erase writing surface 306 and/or graphic layer 308 as explained above in relation to the other illustrated implementations.

A magnetically attractable layer 312 is also positioned behind dry erase writing surface 306 and graphic layer 308. As shown by FIG. 8, magnetically attractable layer 312 is securable via adhesive or another attachment mechanism. Thus, dry erase board 302 may also serve as a magnetic board. Magnets, such as magnet 314, may attach a note or other paper to dry erase writing surface 306 as shown by FIG. 7.

As shown by FIG. 8, the magnetically attractable layer 312 can include cut outs 313 at the corners thereof. The cutouts 313 can ensure that the removable fasteners 310 do not extend through the magnetically attractable layer 312. Thus, the magnetically attractable layer 312 may not be disturbed when replacing the graphic layer 308.

Cork board section 304 is adjacent to dry erase board section 302. Specifically cork board section 304 comprises a cork board material 316, which is positioned to the right of dry erase board section 302. Cork board material 316 is securable to backing member 320 via an adhesive or another attachment mechanism. One or more pushpins, such as pushpin 318, may be used to secure notes or other papers to cork board material 316.

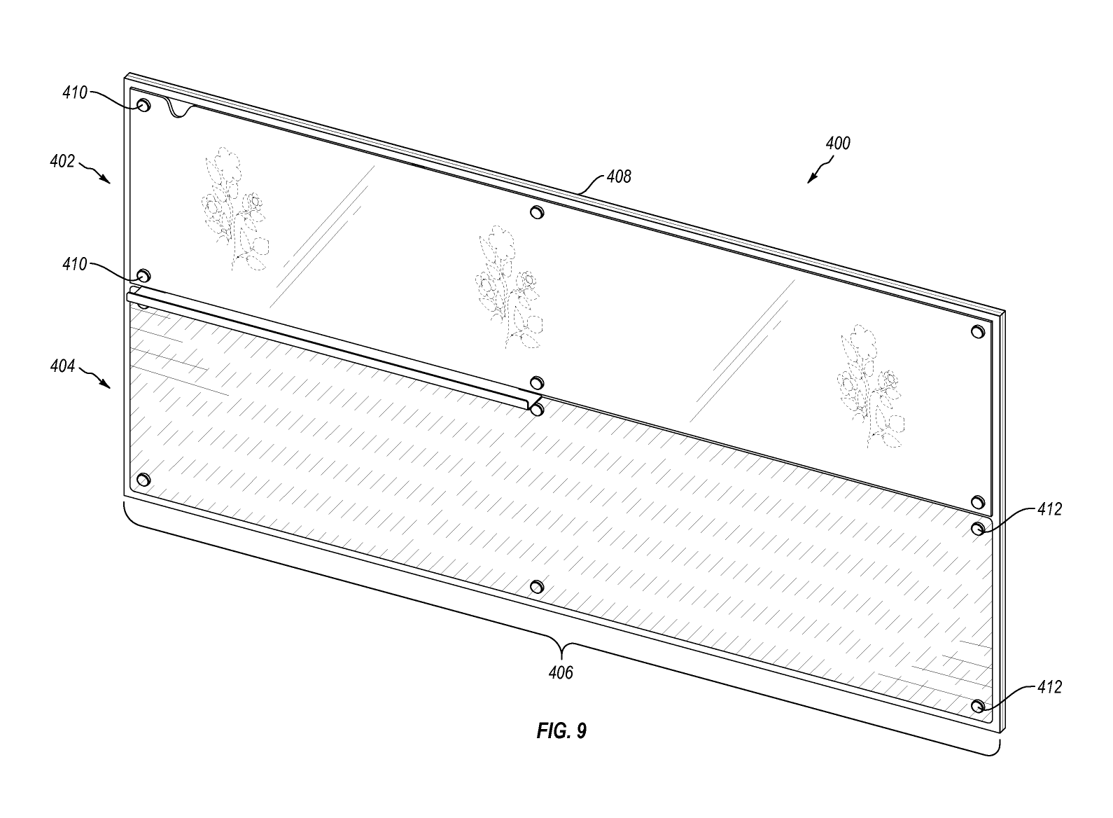

FIG. 9 illustrates another information board 400 according to the present invention. Specifically, information board 400 includes a dry erase board section 402, a cork board section 404, and a magnetic board section 406. Dry erase board section 402, cork board section 404, and magnetic board section 406 are secured to backing member 408. Unlike information board 200, dry erase board section 402 is positioned above cork board section 404.

Dry erase board section 402 is secured to backing member 408 via an attachment mechanism, which comprises six set screws 410. Set screws 410 may be selectively disengaged such that dry erase board section 402 may be removed in whole or in part from backing member 408.

Cork board section 404 attaches to backing member 408 via an attachment mechanism, which also comprises six set screws 412. Set screws 412 are configured to allow a user to selectively disengage them so as to be able to remove cork board section 404 in whole or in part from backing member 408. Magnetic board section 406 of information board 400 extends behind both dry erase board section 402 and cork board section 404. Thus, magnets may secure information and other things to both dry erase board section 402 and cork board section 404.

Because both dry erase board section 402 and cork board section 404 are both selectively removable from backing member 408, a person may customize information board 400 in a desired way. For example, a person may remove cork board section 404 and replace it with a second dry erase board section.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. An information board comprising:
a backing member having a front side and a back side;
a transparent or semi-transparent dry erase writing surface;
a graphic layer positioned between the dry erase writing surface and the backing member; and
a non-permanent attachment mechanism that secures the graphic layer between the dry erase writing surface and the backing member such that the graphic layer may be selectively removed and replaced.

2. The information board as recited in claim 1, further comprising:
a magnetically attractable layer,
wherein the magnetically attractable layer is secured to the backing member via a permanent attachment mechanism.

3. The information board as recited in claim 1, further comprising:
a magnetically attractable layer,
wherein:
the magnetically attractable layer is positioned at least partially behind the graphic layer; and
the magnetically attractable layer is secured to the backing member via the non-permanent attachment mechanism.

4. The information board as recited in claim 3, wherein the front side of the backing member includes a recessed portion into which all or part of the magnetically attractable layer is secured.

5. The information board as recited in claim 1, wherein the non-permanent attachment mechanism comprises one or more fasteners that extend through one or more holes in the dry erase writing surface and the graphic layer, and into threaded openings in the backing member.

6. The information board as recited in claim 1, wherein:
the non-permanent attachment mechanism comprises a spacing member positioned between the dry erase writing surface and the backing member; and
wherein the spacing member creates a gap between the dry erase writing surface and the backing member into which the graphic may be removably positioned.

7. The information board as recited in claim 6, wherein the dry erase writing surface includes an indentation along at least one side, the indentation exposing the graphic layer.

8. The information board as recited in claim 1, further comprising a cork board material, wherein the cork board material is secured to the front side of the backing member adjacent to the dry erase writing surface.

9. The information board as recited in claim 8, wherein the cork board material is secured to the front side of the backing member via a permanent attachment mechanism.

10. The information board as recited in claim 8, wherein the cork board material is secured to the front side of the backing member via a second non-permanent attachment mechanism, the second non-permanent attachment mechanism being selectively disengageable in order to remove the cork board material from the front side of the backing member.

11. An information board comprising:
a backing member having a front side and a back side;
a magnetically attractable layer positioned in front of the front side of the backing member;
a graphic layer positioned in front of the magnetically attractable layer so as to at least partially conceal the magnetically attractable layer;
a dry erase writing surface positioned in front of the graphic layer, the dry erase writing surface being transparent or translucent such that the graphic layer is visible through the dry erase writing surface; and
a non-permanent attachment mechanism that secures the graphic layer and the dry erase writing surface to the backing member such that the graphic layer and the dry erase writing surface may be selectively detached from the backing member.

12. The information board as recited in claim 11, wherein the non-permanent attachment mechanism comprises one or more fasteners that extend through one or more holes in the dry erase writing surface and the graphic layer, and into threaded openings in the backing member.

13. The information board as recited in claim 12, wherein the magnetically attractable layer and the graphic layer are at least approximately the same size as the dry erase writing surface.

14. The information board as recited in claim 13, wherein the magnetically attractable layer secured is to the front side of the backing member via an adhesive.

15. The information board as recited in claim 13, further comprising a tray member positioned adjacent an edge of the dry erase writing surface, the tray member being configured to hold a dry erase maker.

16. The information board as recited in claim 13, further comprising a cork board section, wherein the cork board material is secured to the front side of the backing member and adjacent to at least one side of the dry erase writing surface.

17. An information board comprising:
a backing member having a front side and a back side;
a graphic layer positioned in front of the backing member so as to at least partially conceal the backing member;
a dry erase writing surface positioned in front of the graphic layer, the dry erase writing surface being transparent or translucent such that the graphic layer is visible through the dry erase writing surface;
a self-aligning mounting mechanism configured to removably secure the backing member to a support surface, the self-aligning mounting mechanism comprising:
a triangular aperture extending into the back side of the backing member; and
a triangular or trapezoidal mounting bracket configured to mate and self-align with the triangular aperture; and
a non-permanent attachment mechanism that secures the graphic layer and the dry erase writing surface to the backing member such that the graphic layer and the dry erase writing surface may be selectively detached from the backing member.

18. The information board as recited in claim 17, wherein the non-permanent attachment mechanism is independent from the self-aligning mounting mechanism so the graphic layer and the dry erase writing surface may be selectively detached from the backing member without dismounting the backing layer from the support surface.

19. The information board as recited in claim 18, further comprising a magnetically attractable layer positioned between the graphic layer and the backing member.

20. The information board as recited in claim 19, further comprising a cork board material, wherein the cork board material is secured to the front side of the backing member adjacent to the dry erase writing surface.
